(19) United States
(12) Patent Application Publication
(10) Pub. No.: US 2026/0119112 A1
(43) Pub. Date: Apr. 30, 2026

(54) SYSTEMS AND METHODS FOR CHANGING AUDIO SETTINGS

(71) Applicant: Dell Products L.P., Round Rock, TX (US)

(72) Inventors: Kearson M. McNulty, Austin, TX (US); Walter Kemp, Georgetown, TX (US); Kai Wang, Shanghai (CN)

(73) Assignee: Dell Products L.P., Round Rock, TX (US)

(21) Appl. No.: 18/927,306

(22) Filed: Oct. 25, 2024

(51) Int. Cl. G06F 3/16; G06F 3/01

(52) U.S. Cl. CPC G06F 3/165; G06F 3/011

(57) ABSTRACT

An agent application tracks a physical presence status of the user with respect to an information handling system (IHS) and also tracks a use status of a headset or other wearable audio device. The agent application may initialize or change audio input settings and audio output settings based on at least the two statuses.

### FIELD

This disclosure relates generally to Information Handling Systems (IHSs), and more specifically, to systems and methods for switching audio settings.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

According to one embodiment, a method includes: providing an audio input and output on a first device during use of a conferencing application; determining whether a user is wearing the first device; determining whether the user is detected as present by an information handling system (IHS); and changing the audio input and output to a second device based on both determining whether the user is wearing the first device and determining whether the user is detected as present.

According to one embodiment, an Information Handling System (IHS), includes: a processor; and a memory coupled to the processor, the memory having program instructions stored thereon that, upon execution by the processor, cause the IHS to: perform a first determination of whether a user is detected as physically present at the IHS; perform a second determination of whether the user is wearing a wearable audio device; and implement an audio input and output setting based on the first determination and the second determination.

According to one embodiment, a hardware memory device having program instructions stored thereon that, upon execution by a processor of an Information Handling System (IHS), cause the IHS to: monitor a physical presence status of a user with respect to the IHS; monitor a use status of a wearable audio device of the user; and change from a first audio input and output setting to a second audio input and output setting based upon both the physical presence status and the use status.

### BRIEF DESCRIPTION O F THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a block diagram of components of an example Information Handling System (IHS), according to some embodiments.

FIG. 2 is an illustration of an example wireless headset, which may be used with the IHS of FIG. 1, according to some embodiments.

FIG. 3 is an illustration of an example arrangement for determining audio input and output settings, according to some embodiments.

FIG. 4 is an illustration of an example method, for initializing or setting audio input and output settings, according to some embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An example of an IHS is described in more detail below. It should be appreciated that although certain embodiments are discussed in the context of a personal computing device, other embodiments may utilize various other types of IHSs.

Human users may work in environments that include multiple IHSs (e.g., laptop computers, desktop computers, smart phones) and multiple audio input/output devices. As a human user may move around a physical space, perhaps from IHS to IHS or room to room, the human user may discover that various audio information is missed. For instance, a user may work with a headset coupled to a laptop computer. The user may remove the headset and then move about the physical space. However, the audio setting for the laptop computer may continue to use the headset for audio input and output. An incoming call, which uses an audio jingle to alert the user, may be directed through the headset and, thus, may not be heard by the user.

Various embodiments described herein may work to initialize or change audio input and output settings adaptively based on different detected statuses. For instance, an agent application may monitor a physical presence status of the human user with respect to an IHS (e.g., a laptop computer) and may also monitor a use status of a wearable audio device of the user. An example of a wearable audio device may include wireless earbuds, wired earbuds, a headset, smart glasses, and/or the like. In this example, the IHS includes a human presence detection application, and the wearable audio device may include wearing detection, and the human presence detection status and the wearing detection status may be inputs that are fed to the agent. Therefore, the agent may monitor the physical presence status of the human user as well as the use status of the wearable audio device from these inputs.

The agent may use at least the presence status and the use status to determine audio input and output settings. In one example, when a human user is wearing the wearable audio device, and the human user is detected as present by the IHS, the agent may be aware of such status and may set the audio settings so that audio input and output is directed through the wearable audio device.

Subsequently, the human user may walk away from the IHS so that the IHS does not detect the user as being present, though the user may still wear the wearable audio device. The agent detects such status and may transfer the audio connection of the wearable audio device from receiving audio from the IHS to instead receiving audio from a phone (another IHS) that is being carried by the user. Thus, the agent may cause the audio input and output settings to direct audio from the phone through the wearable audio device.

Subsequently to that, the user may return physically to the IHS, where the IHS detects the user's presence, and the user may also remove the wearable audio device. The agent detects this status and changes the audio input and output settings so that the audio input and output is between the IHS and its associated speakers and microphone (e.g., laptop speakers and microphone).

Subsequent to that, the user may walk away from the IHS, so that the IHS determines that the user is not present. Thus, the user may be detected as being away from the IHS and also the use status of the wearable audio device is determined as not being used. The agent, detecting these statuses, may then transfer audio from the IHS to the user's phone. Thus, the audio input and output settings may set the audio input and output between the phone and its associated speakers and microphone. As the physical presence status and the use status of the wearable audio device change over time, the agent may adapt to provide a suitable audio profile.

A potential advantage of some embodiments is that they may increase satisfaction of the human user. For instance, some audio settings may be buried inside applications and menus and may be difficult to reach. Various embodiments may change the audio settings based on detectable statuses, thereby saving effort of the human user.

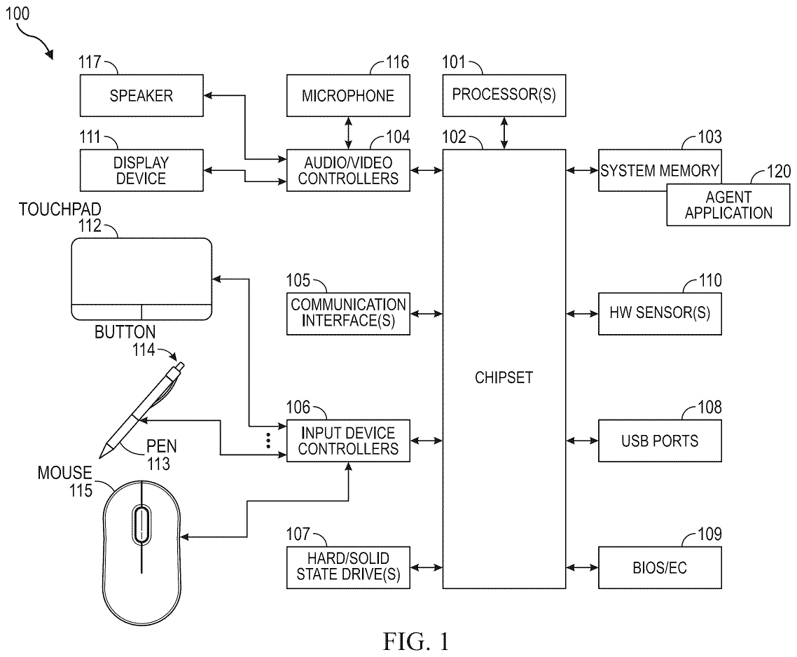

FIG. 1 is a block diagram of components of IHS 100, according to some embodiments. As depicted, IHS 100 includes processor 101. In various embodiments, IHS 100 may be a single-processor system, or a multi-processor system including two or more processors. Processor 101 may include any processor capable of executing program instructions, such as a PENTIUM series processor, or any general-purpose or embedded processors implementing any of a variety of Instruction Set Architectures (ISAs), such as an x86 ISA or a Reduced Instruction Set Computer (RISC) ISA (e.g., POWERPC, ARM, SPARC, MIPS, etc.).

IHS 100 includes chipset 102 coupled to processor 101. Chipset 102 may provide processor 101 with access to several resources. In some cases, chipset 102 may utilize a QuickPath Interconnect (QPI) bus to communicate with processor 101. Chipset 102 may also be coupled to communication interface(s) 105 to enable communications between IHS 100 and various wired and/or wireless networks, such as Ethernet, WiFi, BLUETOOTH, cellular or mobile networks (e.g., CDMA, TDMA, LTE, etc.), satellite networks, or the like. In some cases, communication interface(s) 105 may be coupled to chipset 102 via a PCIe bus.

Chipset 102 may be coupled to audio and video controllers 104, which may include one or more or graphics processor(s) (GPUs) on a graphics bus, such as an Accelerated Graphics Port (AGP) or Peripheral Component Interconnect Express (PCIe) bus. As shown, audio and video controllers 104 provide video or display signals to display device 111. In other implementations, any number of display controller or display devices may be used.

Audio and video controllers 104 are also coupled to microphone 116 and speaker 117 and may provide audio input and output functionality between the processors 101 and the microphone 116 and speaker 117. In one example, the microphone 116 and speaker 117 may be physically combined into a single wearable unit, such as a headset or wired earbuds. Furthermore, the microphone 116 and speaker 117 may be physically integrated into a housing of the IHS (e.g., a laptop computer). In yet another example, microphone 116 and speaker 117 may be integrated into a wireless device, such as wireless earbuds, smart glasses, wireless headset, and/or the like. In such an example, the wireless device having microphone 116 and speaker 117 may communicate with the processors 101 via the communication interface 105 rather than through the audio and video controllers 104. It should be noted that various implementations may include any appropriate quantity of microphones and speakers, whether wired or wireless, whether integrated into a housing of the IHS or not, and whether coupled to the processors 101 via the audio and video controllers 104 or through the communication interfaces 105.

Display device 111 may include Liquid Crystal Display (LCD), Light Emitting Diode (LED), organic LED (OLED), or other thin film display technologies. Display device 111 may include a plurality of pixels arranged in a matrix, configured to display visual information, such as text, two-dimensional images, video, three-dimensional images, etc. In some cases, display device 111 may be provided as a single continuous display, rather than two discrete displays.

Chipset 102 may provide processor 101 and/or audio and video controllers 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a solid-state drive (SSD) or the like.

Chipset 102 may also provide access to one or more hard disk and/or solid-state drives 107. In certain embodiments, chipset 102 may also provide access to one or more optical drives or other removable-media drives. In certain embodiments, chipset 102 may also provide access to one or more Universal Serial Bus (USB) ports 108.

Chipset 102 may further provide access to input device controllers 106, for example, a super I/O controller, firmware or software functionality, or the like. Examples of user input devices which may be communicatively coupled to input device controllers 106 include, but are not limited to, a keyboard, mouse 115, touchpad 112, stylus or pen 113 (with button or switch 114), totem, etc. Input device controllers 106 may represent multiple controllers, such that each of the user input devices may correspond to a respective controller (e.g., a touchpad may have its own touchpad controller). Each of the input devices may interface with its respective controller 106 through a wired or wireless connection (e.g., via communication interfaces(s) 105).

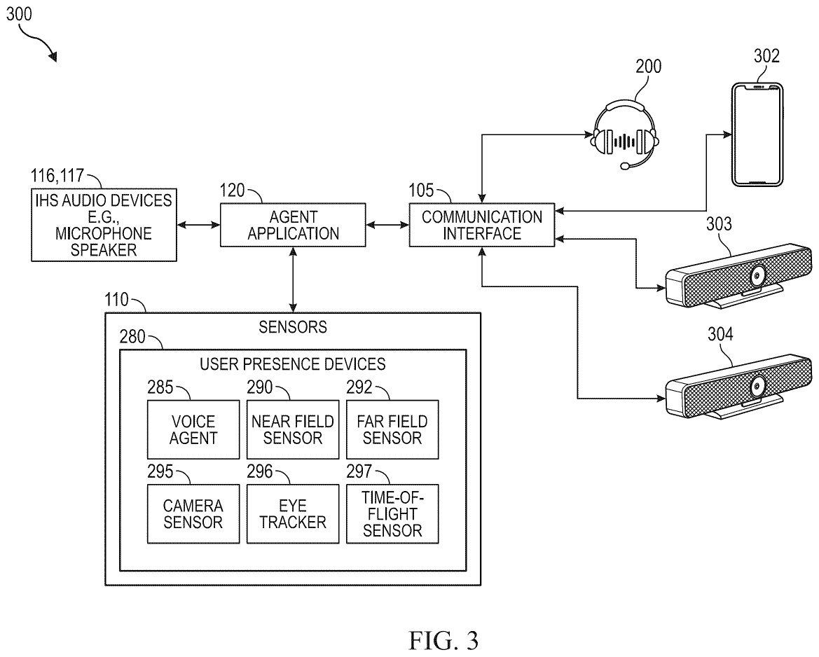

In certain embodiments, chipset 102 may also provide an interface for communications with one or more hardware sensors 110. Sensors 110 may be disposed on or within the chassis of IHS 100, and may include, but are not limited to: electric, magnetic, radio, optical, infrared, thermal, force, pressure, acoustic, ultrasonic, proximity, position, deformation, bending, direction, movement, velocity, rotation, and/or acceleration sensor(s). In some examples, the sensors 110 may be used for user presence detection, as described in more detail with respect to FIG. 3.

Upon booting of IHS 100, processor(s) 101 may utilize Basic Input/Output System (BIOS) instructions of BIOS/Embedded Controller (EC) 109 to initialize and test hardware components coupled to IHS 100 and to load an OS for use by IHS 100. The BIOS provides an abstraction layer that allows the OS to interface with certain hardware components that are utilized by IHS 100. Via the hardware abstraction layer provided by the BIOS, software stored in system memory 103 and executed by processor 101 can interface with certain I/O devices that are coupled to IHS 100. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

EC 109 may be installed as a Trusted Execution Environment (TEE) component to the motherboard of IHS 100. EC 109 may implement operations for interfacing with a power adapter in managing power for IHS 100. Such operations may be utilized to determine the power status of IHS 100, such as whether IHS 100 is operating from battery power or is plugged into an AC power source. Firmware instructions utilized by EC 109 may be used to provide various core operations of IHS 100, such as power management and management of certain modes of IHS 100 (e.g., turbo modes, maximum operating clock frequencies of certain components, etc.).

EC 109 may also implement operations for detecting certain changes to the physical configuration or posture of IHS 100 and managing the modes of a touchpad or other user input device 106 in different configurations of IHS 100. For instance, where IHS 100 as a 2-in-1 laptop/tablet form factor, EC 109 may receive inputs from a lid position or hinge angle sensor 110, and it may use those inputs to determine: whether the two sides of IHS 100 have been latched together to a closed position or a tablet position, the magnitude of a hinge or lid angle, etc.

The system memory 103 may store computer-readable instructions, which when executed by processors 101, may provide functionality for setting and changing audio settings based on various statuses, such as a physical presence status of a user with respect to IHS 100 and a use or wearing status of an audio input and output device. For instance, the system memory 103 may store computer-readable instructions to implement the agent application 120, and the agent application 120 is described in further detail below.

In other embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components. For example, all or a portion of the operations executed by the illustrated components may instead be provided by components integrated into processor(s) 101 as systems-on-a-chip. As such, in certain embodiments, IHS 100 may be implemented as different classes of computing devices including, but not limited to: servers, workstations, desktops, laptops, appliances, video game consoles, tablets, smartphones, etc.

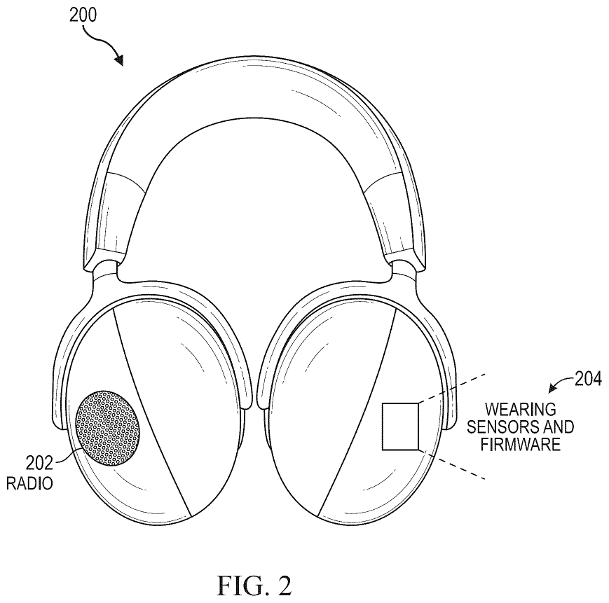

FIG. 2 is an illustration of an example wireless headset 200, which may be used with the IHS 100 of FIG. 1, according to some embodiments. For instance, the wireless headset 200 may include a microphone and speakers, such as microphone 116 and speaker 117, and a radio 202, which may communicate wirelessly with the processors 101 via the communication interface 105. A user may wear headset 200 and receive sound output through speakers (not shown) of the headset 200. The user may also wear headset 200 and provide sound input via a microphone (not shown) of the headset 200.

Headset 200 may further include wearing sensors and firmware 204. For instance, wearing sensors and firmware 204 may include any appropriate sensor to detect that the headset 200 is being worn by a user, such as a light sensor or other sensor, and the firmware may operate in conjunction with the appropriate sensor to detect a use status of the headset 200. In some examples, a use status may correspond to a wearing status, such that when the wearing sensors and firmware 204 determine that a user is not wearing headset 200, that may correspond to a negative use status, and when the wearing sensors and firmware 204 determine that a user is wearing headset 200, that may correspond to a positive use status. The firmware may communicate the use status to the agent application 120 via the radio 202.

FIG. 3 is an illustration of an arrangement 300, according to some embodiments. In an arrangement 300, the agent application 120 is running on the processors 101, and the agent application 120 is in communication with sensors 110, the IHS audio devices (e.g., microphone 116 and speaker 117) via audio and video controllers 104 (not shown), and communication interface 105. Communication interface 105 communicatively couples the agent application 120 to headset 200, smart phone 302, and speaker devices 303-304. Smart phone 302 may be configured as an IHS (e.g., IHS 100 of FIG. 1). The speaker devices 303-304 may be configured as smart speakers, having processors that run firmware to provide functions, such as wireless communication, audio settings control, and the like.

Sensors 110 include user presence devices 280. User presence devices 280 are in communication with agent application 120, thereby allowing agent application 120 to monitor user presence at IHS 100. User presence devices 280 are shown as an example, and it is understood that various implementations may use fewer devices, more devices, and/or different devices to determine user presence.

User presence devices 280 include a voice agent 285, a near-field sensor 290, a far-field sensor 292, a camera sensor 295, an eye tracker 296, and a time-of-flight sensor 297. Other devices that may be used to detect the user presence status, user presence states, or user behavior, such as radar sensors, magnetic sensors, capacitive sensors, inductive sensors, Wi-Fi sensors, ultrasonic sensors or similar may be included. For example, user presence devices 280 may include a visual sensor, such as Emza WiseEye® visual sensor, which may be configured to pick up a two-dimensional image of the object being measured. Each of the user presence devices 280 may be communicatively coupled to agent application 120 through wireless local area networks such as 802.11 b, g, n, and ac networks, through wireless personal area networks such as Bluetooth or 802.11 ad networks, or other communication networks. User presence devices 280 may communicate an output such as a signal and/or a data stream in various formats to the agent application 120. For example, the stream of data may be in Extensible Markup Language™, JavaScript Object Notation™, or other formats.

Ranging and proximity sensors, such as near-field sensor 290, a mid-field sensor, and a far-field sensor 292 may include any system, device, or apparatus configured to detect the presence, the gaze of the user, and other parameters such as the direction of movement, size, and speed. The ranging and proximity sensors may communicate a data output such as signal, data stream, or both to agent application 120. Near-field sensor 290 may provide ranging and proximity sensing of user presence at a first range around the IHS and other parameters such as the direction of movement, size, and speed. Near-field sensor 290 may communicate output to a near-field user awareness service of agent application 120 using a near-field communication protocol. Near-field sensor 290 may be one sensor or a combination of multiple sensors that include a proximity sensor, a time-of-flight (TOF) sensor, an eye tracker, a charge to voltage sensor, a visual sensor, and a motion sensor, etc.

Far-field sensor 292 may provide ranging and proximity sensing of user presence in a second range which may be further than the first range around the information handling system and other parameters such as the direction of movement, size, and speed. Far-field sensor 292 may communicate output such as a signal or a stream of data to agent application 120. Far-field sensor 292 may be one sensor or a combination of multiple sensors that include a camera, Bluetooth user presence sensor, Bluetooth low energy user presence sensor, etc. Similarly, a mid-field sensor may provide ranging and proximity sensing of user presence in a third range which may be between the first range and the second range.

Time-of-flight sensor 297, such as FlightSense® TOF ranging sensor sense, may be configured to detect the movement of the user in addition to user presence and absence. In particular, the TOF sensor may be configured to scan infrared energy in a pattern at an expected user location and measure reflections to detect objects. In addition, the TOF sensor may enable facial recognition and can distinguish a person sitting in front of display device 111 of information handling system 100 from an inanimate object, such as a chair.

Eye tracker 296 may be configured to measure eye movements to determine where the user is looking, what the user is looking at, and for how long the user is gazing at a particular spot. Eye tracker 296 may use a near-infrared light and/or high definition camera to record the direction it is reflected off the cornea and calculate the position of the eye to determine where it is focused. Camera sensor 295 may be configured to detect user presence and/or focus based on one or more signals or data streams from a camera. Camera sensor 295 may be one of the charge-coupled devices, electron-multiplying charge-coupled devices, complementary metal-oxide-semiconductor (CMOS), back-illuminated CMOS, or similar.

Voice agent 285 may detect a user's voice and determine from various qualities of the voice whether the user is proximate the IHS 100.

In this example, the agent application 120 monitors the physical presence status of the user via one or more of the user presence devices 280 and further monitors a use status of headset 200. For instance, the headset 200 may include sensors, as discussed above with respect to FIG. 2, thereby allowing headset 200 to determine whether it is being worn by a human user. The headset 200 may be communicatively coupled to the agent application 120 to communicate its use status to the agent application 120. In this way, the agent application 120 may monitor the use status of the headset 200.

Additionally, while FIG. 3 is shown to include headset 200, it is understood that any wearable audio device, such as earbuds or smart glasses, may be configured similarly and be in communication with agent application 120 in a same or similar manner as headset 200 is configured in FIG. 3.

Also, while agent application 120 is discussed in these examples as running on processors 101 of IHS 100, such as on a laptop of the human user, it is understood that agent application 120 may be run on any appropriate device. For instance, in another implementation, the agent application 120 may be run on a different type of IHS, such as a smart phone. In yet another example, the agent application 120 may be run on a dedicated piece of hardware. In any event, agent application 120 may be instantiated and run in any appropriate location and on any appropriate device, as long as agent application 120 may be communicatively coupled to IHS presence detection, a wearable audio device that includes wearing sensors and firmware/software, and a variety of audio devices from which to select.

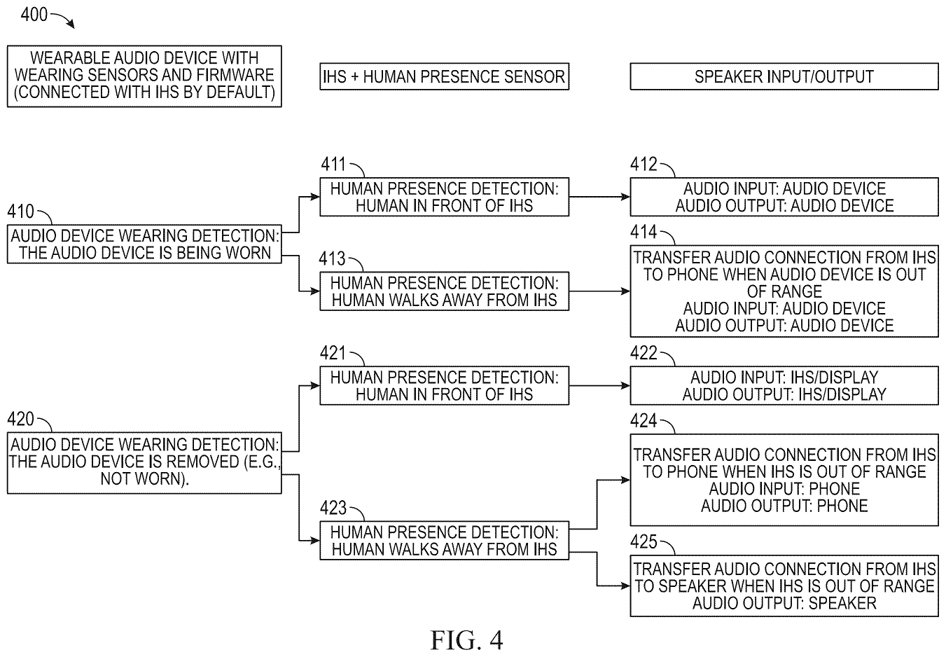

FIG. 4 is an illustration of example method 400, for initializing or setting audio input and output settings, according to some embodiments. Method 400 may be performed by an agent application, such as agent application 120 of FIG. 3. FIG. 4 is discussed with respect to FIG. 3 as an example.

Actions 410 and 420 represent monitoring a use status of a wearable audio device, such as headset 200. Actions 411, 413, 421, and 423 represent monitoring a physical presence of a user. Actions 412, 414, 422, 424, and 425 represent implementing or changing an audio input and output setting based upon monitoring the physical presence status and monitoring the use status of the wearable audio device.

The various actions described with respect to FIG. 4 may be performed while a human user is using some type of work or recreation application. For instance, the human user may be on a conferencing application, which includes audio and video streaming and bidirectional conversation. In another example, the user may be using a music streaming application. In any event, the IHS (e.g., IHS 100) may run those applications or different applications, thereby providing audio output and/or input for the user. Furthermore, the IHS may run the agent application 120 as well.

At action 410, the wearable audio device detects that it is being worn by a human user. For instance, the wearable audio device may include wearing sensors and firmware 204, which make a determination as to whether a human user is wearing the wearable audio device or not. The wearable audio device may then transmit an indication of that status to agent application 120.

At action 411, the IHS determines that the human user is present at the IHS. Different techniques for determining human presence at an IHS are discussed above with respect to user presence detection devices 280. The human presence detection devices 280 (or other appropriate devices) may then transmit an indication of that status to the agent application 120.

At action 412, the agent application 120 makes a decision regarding audio input and output settings based upon the statuses determined at actions 410 and 411. In the case of action 412, the agent application 120 is aware that the audio device (e.g., headset 200) is being worn and the human user is present at the IHS and, in response, the agent application 120 sets the wearable audio device as the input and output device. In this example, the wearable audio device may be as a default communicatively coupled with the IHS, so that the audio output is received by the wearable audio device from the IHS, and the audio input is provided from the wearable audio device to the IHS.

Action 413 represents a counterfactual of action 411. At action 413, the IHS determines that the human user is not physically present at the IHS (e.g., the human user may have walked away). However, the determination of action 410 is still true. In the case of action 414, the agent application 120 makes a decision based upon the statuses determined at actions 410 and 413. Specifically, at action 414, the agent application 120 transfers the audio connection from the IHS to the user's phone 302. For instance, in some scenarios, the human user may be using a same or similar conferencing application or other application on the phone 302 as on the IHS. Additionally, the wearable audio device may support multiple connections at the same time, such as being connected to both the IHS and the phone 302 with a default setting to the IHS. Action 414 may include causing the wearable audio device (e.g., headset 200) to pause the connection to the IHS and un-pause the connection to the user's phone 302. As a result, the user may receive audio output from the phone 302 via the wearable audio device and when speaking to the microphone of the wearable audio device, may transmit audio input to the phone 302. Action 414 may ensure that the user does not lose connectivity when physically away from the IHS. Action 414 may also be performed further based upon a determination that the user is using the phone 302 and/or a determination that the user is using a same or similar application on the phone 302 as on the IHS.

An example of implementing action 414 may include using a wireless protocol that provides multiple simultaneous connections from the wearable audio device to, e.g., the IHS and the phone 302. An example wireless protocol that may be used may include Bluetooth Multipoint, though the scope of embodiments may include any appropriate wireless protocol.

Action 420 includes the wearable audio device (e.g., headset 200) detecting that it is not being worn by the user. For instance, the wearing sensors and firmware 204 may detect that the human user is not wearing the wearable audio device, and the wearable audio device may transmit an indication of that status to the agent application 120.

At action 421, the agent application 120 may determine that the human is detected as being present at the IHS. Thus, at action 421, the physical presence status of the user is positive and the wearing status or use status of the wearable audio device is negative. As a result, the agent application 120 decides to go to action 422. Action 422 may include changing the audio input and output so that the audio input and output goes through a speaker and a microphone associated with the IHS (e.g., IHS 100). Examples of a speaker and a microphone associated with the IHS may include a speaker and a microphone (e.g., 117 and 116) that are included within a housing of a laptop computer, included within a housing of a display device that is associated with the IHS, a standalone speaker and microphone that is plugged into the IHS, and/or the like.

At action 423, the determination at action 420 is still true. However, at action 423, the agent application 120 determines that the human is not indicated as present at the IHS. For instance, presence detection devices 280 may indicate to the application 120 that the human user is not present that the IHS. At this point, the agent application 120 has an indication of the use status of the wearable audio device and the presence status of the human user. As a result, the agent application 120 decides to perform either action 424 or 425.

At action 424, the agent application 120 transfers the audio connection from the IHS to the user's phone 302 based on determining that the IHS is out of range. In one example, the audio settings may be set so that the speaker and microphone associated with the IHS is in use, as at action 422, then the user physically leaves the presence of the IHS. The agent application 120 may further determine that the user's phone 302 is in use and perhaps even in use on a same or similar application as at the IHS, and as a result, the agent application 120 may transfer the audio connection to the phone 302. For instance, the phone 302 may have an integrated speaker and microphone, and the agent application 120 may cause the audio input and output of the IHS to be paused and may cause the audio input and output at the phone 302 to be activated. In an example in which the user is using a conferencing application on both the IHS and the smart phone, action 424 may include the agent application 120 causing the user's audio input and output to switch from the IHS speakers and microphone to the phone's 302 speakers and microphone.

Action 425 may be performed instead of action 424, based on a further determination by the agent application 120 that the phone 302 is not available. For instance, the user's phone 302 may not be in communication with the agent application 120, the user's phone 302 may not have a same or similar application running as on the IHS, or other condition that may prevent the phone 302 from being an appropriate audio input and output device. Action 425 may include the agent application 120 transferring the audio connection from the speaker and microphone associated with the IHS to a separate speaker, such as speakers 303 or 304 of FIG. 3. Any appropriate wireless protocol may be used to transfer audio input and output from one speaker to another speaker. For instance, Bluetooth Multichannel audio may allow for multiple devices to receive a same stream at the same time. Assuming that the speakers 303 and 304 have presence detection and may communicate presence of the user back to the agent application 120, the agent application 120 may detect that additional status and may choose to go to action 425 based on that presence. In fact, the agent application 120 may choose among different available speakers (e.g., 303 and 304) based on presence information from those speakers. The user may then receive audio output via the speaker and use a microphone associated with a speaker for audio input.

The scope of implementations is not limited to any particular order of performing status detection. For instance, during use of an IHS and a wearable audio device, a user may wear or remove the wearable audio device and may approach or walk away from the IHS, thereby changing the statuses. Thus, the agent application may monitor the physical presence status of the user, which may change from time to time, and may monitor the use status of the wearable audio device, which may also change from time to time. The agent application may initialize or change the audio input and output settings as appropriate based upon the statuses. For instance, the agent application 120 may set some audio input and output settings, and subsequent to that, one or both of the statuses may change, and agent application 120 may change the audio input and output settings accordingly.

Furthermore, the scope of implementations is not limited to any particular audio input and output devices. Rather, the principles described herein may be applied in any system that has a multitude of audio input and output devices from which to choose and/or that has a multitude of IHSs from which to choose.

To implement various operations described herein, computer program code (i.e., instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination thereof. Such configured devices are physically designed to perform the specified operation(s).

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

In many implementations, systems and methods described herein may be incorporated into a wide range of electronic devices including, for example, computer systems or Information Technology (IT) products such as servers, desktops, laptops, memories, switches, routers, etc.; telecommunications hardware; consumer devices or appliances such as mobile phones, tablets, wearable devices, IoT devices, television sets, cameras, sound systems, etc.; scientific instrumentation; industrial robotics; medical or laboratory electronics such as imaging, diagnostic, or therapeutic equipment, etc.; transportation vehicles such as automobiles, buses, trucks, trains, watercraft, aircraft, etc.; military equipment, etc. More generally, these systems and methods may be incorporated into any device or system having one or more electronic parts or components.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method comprising:
providing an audio input and output on a first device during use of a conferencing application;
determining whether a user is wearing the first device;
determining whether the user is detected as present by an information handling system (IHS); and
changing the audio input and output to a second device based on both determining whether the user is wearing the first device and determining whether the user is detected as present.

2. The method of claim 1, wherein providing the audio input and output on the first device comprises providing the audio input and output on a headset.

3. The method of claim 1, wherein providing the audio input and output on the first device comprises providing the audio input and output on a wearable audio device other than a headset.

4. The method of claim 1, wherein changing the audio input and output to the second device comprises:
changing the audio input and output to a speaker and a microphone of the IHS in response to determining that the user is not wearing the first device and that the user is detected as present by the IHS.

5. The method of claim 1, wherein changing the audio input and output to the second device comprises:
changing the audio input and output to a speaker and a microphone of a second IHS in response to determining that the user is not wearing the first device and that the user is not detected as present by the IHS.

6. The method of claim 5, wherein changing the audio input and output to the speaker and the microphone of the second IHS is further performed in response to determining that the second IHS is running the conferencing application.

7. The method of claim 1, wherein changing the audio input and output to the second device comprises:
changing the audio input and output to a speaker and a microphone remote from the IHS in response to determining that the user is not wearing the first device and that the user is not detected as present by the IHS.

8. The method of claim 7, wherein changing the audio input and output to the speaker and the microphone remote from the IHS is further performed in response to determining that the user is detected as present by the speaker and the microphone.

9. An Information Handling System (IHS), comprising:
a processor; and
a memory coupled to the processor, the memory having program instructions stored thereon that, upon execution by the processor, cause the IHS to:
perform a first determination of whether a user is detected as physically present at the IHS;
perform a second determination of whether the user is wearing a wearable audio device; and
implement an audio input and output setting based on the first determination and the second determination.

10. The IHS of claim 9, wherein the program instructions to cause the IHS to implement the audio input and output setting comprises program instructions to cause the IHS to:
pause audio input and output to a first device; and
activate audio input and output to a second device.

11. The IHS of claim 9, wherein the program instructions to cause the IHS to perform the first determination comprises program instructions to cause the IHS to: receive an indication of user presence from one or more user presence devices associated with the IHS.

12. The IHS of claim 9, wherein the program instructions to cause the IHS to perform the second determination comprises program instructions to cause the IHS to: receive an indication that the user is wearing the wearable audio device or is not wearing the wearable audio device via wireless communication from the wearable audio device.

13. The IHS of claim 9, further comprising program instructions to cause the IHS to:
determine that a phone is running a same conferencing application as the IHS; and
determine to change the audio input and output from a speaker and a microphone of the IHS to a speaker and a microphone of the phone based on the first determination, the second determination, and on determining that the phone is running the same conferencing application.

14. The IHS of claim 9, wherein the program instructions to cause the IHS to perform the second determination includes program instructions to cause the IHS to:
communicate with functionality in a headset, where the functionality in the headset provides an indication of whether the user is wearing the headset.

15. A hardware memory device having program instructions stored thereon that, upon execution by a processor of an Information Handling System (IHS), cause the IHS to:
monitor a physical presence status of a user with respect to the IHS;
monitor a use status of a wearable audio device of the user; and
change from a first audio input and output setting to a second audio input and output setting based upon both the physical presence status and the use status.

16. The hardware memory device of claim 15, wherein the program instructions to cause the IHS to change from the first audio input and output setting to the second audio input and output setting comprises program instructions to cause the IHS to:
change the audio input and output to a speaker and a microphone of the IHS in response to determining that the use status of the wearable audio device is negative and determining that the physical presence status of the user is positive.

17. The hardware memory device of claim 15, wherein the program instructions to cause the IHS to change from the first audio input and output setting to the second audio input and output setting comprises program instructions to cause the IHS to:
change the audio input and output to a speaker and a microphone of a phone in response to determining that the use status of the wearable audio device is negative and determining that the physical presence status of the user is negative.

18. The hardware memory device of claim 17, wherein the program instructions to cause the IHS to change the audio input and output to the speaker in the microphone of the phone further includes program instructions to cause the IHS to:
determine that the IHS and the phone are running a same conferencing application.

19. The hardware memory device of claim 15, wherein the program instructions to cause the IHS to change from the first audio input and output setting to the second audio input and output setting comprises program instructions to cause the IHS to:
change the audio input and output to a speaker and a microphone remote from the IHS in response to determining that the use status of the wearable audio device is negative and determining that the physical presence status of the user is negative.

20. A hardware memory device of claim 19, wherein the program instructions to cause the IHS to change the audio input and output to the speaker in the microphone remote from the IHS includes program instructions to cause the IHS to:
determine that the user is proximate the speaker in the microphone remote from the IHS.
